(19) United States
(12) Patent Application Publication
(10) Pub. No.: US 2009/0222293 A1
(43) Pub. Date: Sep. 3, 2009

(54) Method and System of Using Commodity Databases in Internet Search Advertising

(76) Inventors: Daniel Wong, San Jose, CA (US); Raghotham Murthy, Palo Alto, CA (US)

Correspondence Address: STATTLER - SUH PC, 60 SOUTH MARKET STREET, SUITE 480, SAN JOSE, CA, 95113, US

(21) Appl. No.: 12/039,537

(22) Filed: Feb. 28, 2008

(51) Int. Cl. G06Q 30/00

(52) U.S. Cl. 705/7; 705/14

(57) ABSTRACT

A method and system are provided for using commodity databases for parallelized and scalable solutions in Internet advertising. In one example, the method includes receiving first-type data and second-type data from one or more web servers, partitioning the first-type data into a particular number of first-type partitions, partitioning the second-type data into second-type partitions, wherein there are a same number of second-type partitions as the particular number of first-type partitions, sorting each first-type event by a second-type timestamp, opening second-type event files and finding first-type event matches, generating annotated second-type data by annotating each second-type event file with data from matching first-type events, and optimizing an advertising model based on the annotated second-type data.

### FIELD OF THE INVENTION

The present invention relates to using commodity databases in Internet search advertising. More particularly, the present invention relates to using commodity databases for parallelized and scalable solutions in Internet advertising.

### BACKGROUND OF THE INVENTION

An advertiser, such as Ford® or McDonald's®, generally contracts an advertising agency for ads in different media for its products. Such media may include banner display ads, textual ads (which may appear as hyperlinks), streaming ads (which stream across a digital display like stock quotes), mobile phone ads, print media ads, for example, in newspapers, magazines and posters. It is quite possible that the advertiser may engage one or more advertising agencies that specialize in creating ads for one or more of the above media.

The search advertising marketplace generates billions of dollars in revenue each year for a search engine, for example, Yahoo!®. The search marketing marketplace works on a cost-per-click (CPC) model. When a user performs a search query online and clicks on a sponsored search text ad, a company like Yahoo!® is paid by the respective advertiser. Users tend to click on more relevant ads. It is the company's best interest to show the most relevant ads to users, in order to get more clicks on these ads. In order to do this, the company needs to gather information about users' Search behavior and Click behavior. Search behavior is what the user searches. Primary evidence for search behavior is the key words used in the user search. Click behavior is what the user click on the search page after a search. The clicks may include clicking to select an ad, clicking to close an ad, etc. The company can then use this information to target relevant ads to different users.

In the CPC model, there are two important events: Search and Click events. Search events occur when a user performs a search query. Click events occur when a user clicks on a sponsored text ad. Web servers of a company like Yahoo!® collect Search events when a user performs a query on the company's search page. Click event information is contained in the URLs of the ads on the search result webpage. The company wants to collect and analyze the Search and Click events in order to build a model for query-to-text ad relevance. If the company can learn which ads are more relevant, then the company can target these ads to users and get a higher click-through rate (CTR).

The problem is that a company like Yahoo!® wants to collect a lot of information in the Click event URL. If the company were to put all of this information in the Click event URL, the size of the search result webpage would be prohibitively large. This means that the hypertext markup language (HTML) would take an unduly long time to load. This delay in load time would degrade the responsiveness of the search page and result in a poor user experience. In fact, the large amount of data that is desired to be stored in the Click event will likely exceed the maximum number of characters allowable in the standard URL length of 1024 characters. Consequently, the company needs a way to collect all of this useful Click information without embedding the Click information in the actual URL.

### SUMMARY OF THE INVENTION

What is needed is an improved method having features for addressing the problems mentioned above and new features not yet discussed. Broadly speaking, the present invention fills these needs by providing a method and system for using commodity databases for parallelized and scalable solutions in Internet advertising. It should be appreciated that the present invention can be implemented in numerous ways, including as a method, a process, an apparatus, a system or a device. Inventive embodiments of the present invention are summarized below.

In one embodiment, a method is provided for using commodity databases for parallelized and scalable solutions in Internet advertising. The method comprises receiving first-type data and second-type data from one or more web servers, partitioning the first-type data into a particular number of first-type partitions, partitioning the second-type data into second-type partitions, wherein there are a same number of second-type partitions as the particular number of first-type partitions, sorting each first-type event by a second-type timestamp, opening second-type event files and finding first-type event matches, generating annotated second-type data by annotating each second-type event file with data from matching first-type events, and optimizing an advertising model based on the annotated second-type data.

In another embodiment, An apparatus is provided for using commodity databases for parallelized and scalable solutions in Internet advertising, the apparatus being configured to receive first-type data and second-type data from one or more web servers. The apparatus comprises a first-type partitions device configured to partition the first-type data into a particular number of first-type partitions, a second-type partitions device configured to partition the second-type data into second-type partitions, wherein there are a same number of second-type partitions as the particular number of first-type partitions, an iterate device configured to sort each first-type event by a second-type timestamp, to open second-type event files, and to find first-type event matches.

In still another embodiment, a system is provided for using commodity databases for parallelized and scalable solutions in Internet advertising, the system including a conglomeration of apparatuses. Each apparatus comprises at least one of a first-type partitions device configured to partition the first-type data into a particular number of first-type partitions, a second-type partitions device configured to partition the second-type data into second-type partitions, wherein there are a same number of second-type partitions as the particular number of first-type partitions, an iterate device configured to sort each first-type event by a second-type timestamp, to open second-type event files, and to find first-type event matches.

In yet another embodiment, a computer readable medium carrying one or more instructions for using commodity databases for parallelized and scalable solutions in Internet advertising is provided. The one or more instructions, when executed by one or more processors, cause the one or more processors to perform the steps of receiving first-type data and second-type data from one or more web servers, partitioning the first-type data into a particular number of first-type partitions, partitioning the second-type data into second-type partitions, wherein there are a same number of second-type partitions as the particular number of first-type partitions, sorting each first-type event by a second-type timestamp, and opening second-type event files and finding first-type event matches.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a system for using commodity databases for parallelized, scalable solutions in Internet search advertising, in accordance with an embodiment of the present invention;

FIG. 2 is a block diagram of data flow through commodity databases, in accordance with an embodiment of the present invention;

FIG. 3 is a more detailed block diagram of the first stage of FIG. 2, in accordance with an embodiment of the present invention;

FIG. 4 is a more detailed block diagram of the second stage of FIG. 2, in accordance with an embodiment of the present invention; and

FIG. 5 is a flowchart of a method for building components needed to match Click events with Search events in a fast and scalable manner, in accordance with an embodiment of the present invention.

### DETAILED DESCRIPTION OF THE INVENTION

An invention for a method and system for using commodity databases for parallelized and scalable solutions in Internet advertising is disclosed. Numerous specific details are set forth in order to provide a thorough understanding of the present invention. It will be understood, however, to one skilled in the art, that the present invention may be practiced with other specific details.

### General Overview

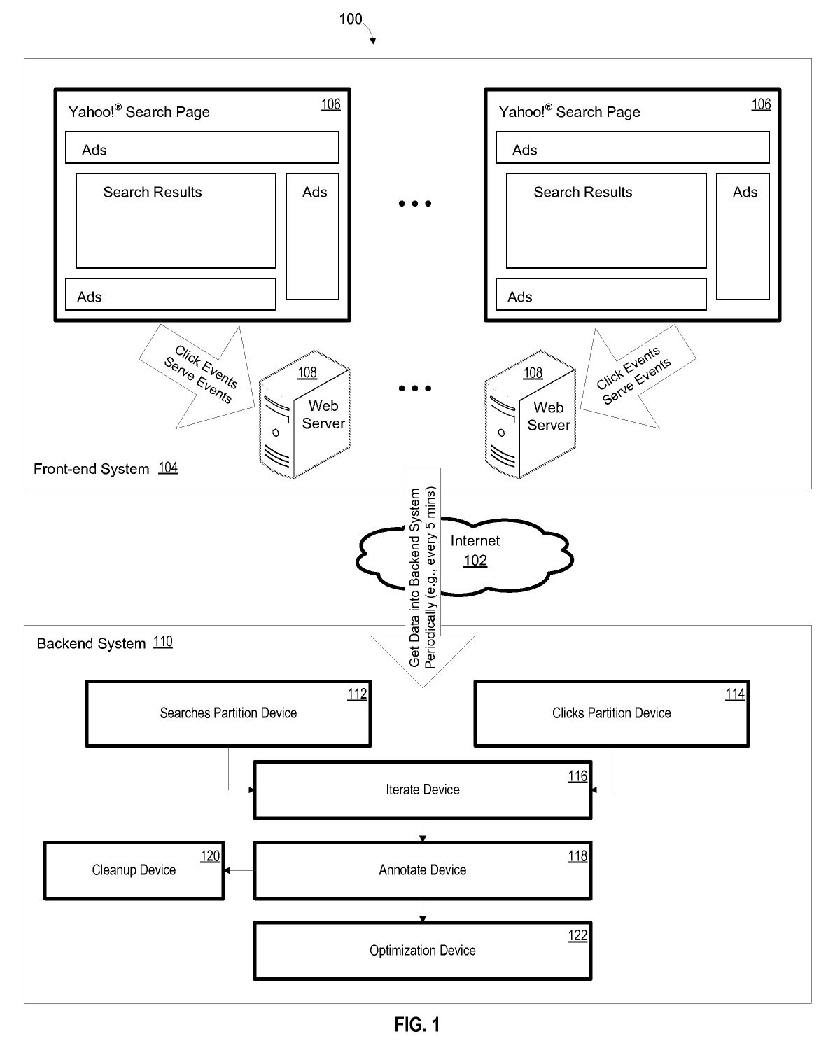

FIG. 1 is a system 100 for using commodity databases for parallelized, scalable solutions in Internet search advertising, in accordance with an embodiment of the present invention. The Internet 102 couples a front-end system 104 to a backend system 110. The Internet 102 is any combination of networks, including but not limited to the Internet, a local area network, a wide area network, a wireless network and a cellular network. A search page 106 generates Search information and Click information based on user input of a browser hosting the search page 106. Each search page is coupled to at least one web server 108. There may be multiple search pages 106 receiving input around the world. Likewise, there may be multiple web servers 108 coupled to these search pages 106 around the world.

The system 100 separates Search information and Click information into two (2) data streams, for example, Click events and Search events. A search occurs when a user performs a web search, for example, for “Lexus cars”. The backend system 110 logs that Search event. Based on that Search event, the backend system 110 figures out which the most desirable ads to show given the user query. The backend system 110 constructs the search results page may include desirable ads that may be interspersed at various locations on the search results page. Each of the ads has a URL that is pointing to the ad server (not shown) from which the ad came. If a user were to click on one these ads, there would be a Click event. A Click event is a selection of an ad on the search results page. In other words, there are a multitude of Search events happening; out of those Search events, some portion of those Search events will lead to clicks.

Note that the method of the present invention is described here using Search data (first-type data) and Click data (second-type data) as examples. However, the embodiment is not so limited. The system may use a generic algorithm involve numerous different types of data sets; in other words, the data sets do not have to be Clicks and Searches; the data sets can be any first-type data and second-type data that the backend system 110 is configured to join or correlate.

The backend system 110 has a goal to merge the two data streams in a fast and scalable manner. The backend system 110 has figure out which Search events lead to a Click event. This end result is smaller search result pages 106 that are faster to load, and provides a scalable way to handle increases in web traffic.

### Illustrative Examples

In the search advertising marketplace, advertisers bid on keywords. When a user searches for items online, a web server 108 displays ads from the advertisers who bid on associated keywords. When a user clicks on a sponsored ad, the advertiser pays a company, such Yahoo!®, based on the Click event. The system 100 provides a way to quickly serve ads to users based on their search query, and track which ads users click. The system 100 collects lots of information about the users who search and click on ads.

However, this information is too large to fit in 1 data stream, and will cause the resulting web page to take a long time to load. Consequently, the system 100 splits this information into 2 data streams—Search events and Click events. The Search events contain information related to the user's search. Such related information may be, for example, a search query, a search identifier, a user's location or a list of all the ads shown to the user, among other information. The Click events contain information related to the ad that the user clicked. Such related information may be, for example, the location of the ad or the number of ads on the page, among other information. In order to understand which ads are most relevant to search queries, the system 100 uses a method of matching the Click events with the corresponding Search events.

A device of the present invention is hardware, software or a combination thereof. Each device is configured to carry out one or more steps for the method of automatically targeting and modifying Internet ads. The back system 110 includes but is not limited to a Searches partition device 112 and a Clicks partition device 114, each device being coupled to an iterate device 116. The iterate device 116 is coupled to an annotate device 118, which is couple to both a cleanup device 120 and an optimization device 122. FIG. 1 shows a simplified backend system 110 for explanatory purposes. The backend system 110 may be one backend apparatus including the devices that are configured to carry out steps of the method of the present invention. Alternatively, the backend system 110 may be a conglomeration of backend apparatuses each including at least one device that is configured to carry out at least one step of the method of the present invention.

The system 100 carries out a method of building components needed to match Click events with Search events in a fast and scalable manner.

The system 100 collects up to a multitude of Search events and Click events from one or more web servers 108, which may be spread around the world. The Search events and Click events are continuously coming in. The system 100 downloads these events to the central backend system 110 in defined intervals. These intervals may also be referred to as “windows”. These windows are preferably about a few minutes, and more preferably about 5 minutes. In other words, the backend system 110 is pulling log files on Search events and Click events from the one or more web servers 108.

From each window, the backend system 110 will collect two (2) streams of data—Search events and Click events. The search data includes all the user searches performed in that window. The Click data includes all the ads that users clicked on in that window. The backend system 110 will save each window of data to a particular timestamp in the data warehouse.

The backend system 110 iterates as necessary over all the Click events in that window to find the corresponding Search event that resulted in that particular Click event. Search events and Click events do not necessarily have to occur within the same window. It is possible, for example, for a Search event to occur as long as 24 hours or more prior to a Click event. The time difference between a Click event and its corresponding Serve event can range from a fraction of a second to several days. One can imagine that the Search events and the Click events add up to a huge amount of data. As the Internet traffic grows, the sizes of the Click data and the Search data grow linearly with respect to the Internet traffic. Accordingly, the backend system 100 needs to find a matching Search event within a huge amount of data. The backend system 100 must be able to scale with increasing data volumes.

One optimization is for the backend system 110 to partition (i.e., hash) the data set in order to reduce the scope of the Search space. In order to find a matching Search event quickly, the backend system 110 organizes the data in an intelligent manner. The backend system 110 splits the Search data into, for example, 512 partitions based on a hash of 2 fields (i.e., hash keys)—SEARCH_ID and SEARCH_TIMESTAMP. The backend system 110, for example, organizes all the Search events into a table called SEARCH_TIMESTAMP and organizes all the Click events into a table called SEARCH_TIMESTAMP. Accordingly, the data streams are organized into a table according the Search identification (ID) and the Search timestamp for that particular five minute interval.

A Search timestamp is when the ad server served the ads on a particular search page 108. A Click timestamp is the time the user clicked on a particular ad URL. The Search ID identifies a particular search query that generated particular ads. The Click ID identifies a particular click on a particular ad. For purposes of this invention, the Click ID and the Click timestamp are not as important as the Search ID and Search timestamp. The Click ID and the Click timestamp are just additional metadata that the backend system may use to build a model for various needs.

For each of the partitions, the backend system 110 splits each record into key-value pairs and loads the record into a commodity database, such as a Berkeley DB (BDB). The backend system 110 may build each commodity database in parallel for reduced processing time.

The Click events will also contain the SEARCH_ID and SEARCH_TIMESTAMP fields. The Click events will also be split into 512 partitions based on a hash of the SEARCH_ID and the SEARCH_TIMESTAMP fields.

A Search event includes all the information about a search results page, for example, the user query terms, the user's Internet Protocol (IP) address, the user's geo-location, the user's browser type, the time of day, Search identification (ID), search timestamp, etc. A Search event is relatively large and is not embedded into the HTML of the search page. On the other hand, a Click event is embedded into the HTML of the search page. A Click event is substantially smaller than the Search event and includes some information about ad placement, Search ID of associated Search event and Search timestamp of associated Search event, etc. Accordingly, the Search data and the Click data both have the Search ID and the Search timestamp. This common association makes up a joint key between a Search event and an associated Click event. Every Click event will have a corresponding Search event (unless, for example, if the Click event way past the window period); however, every Search event does not necessarily have a corresponding Click event.

Even though the Click event is substantially smaller than the Search event, the backend system 110 still needs a way to extract a lot of information about that particular click. The Click event URL will contain the Search ID that caused that Click event URL to be generated. That Search ID may be referred to as the associated Search ID. In order to eventually join the data, the backend system 110 will use the Search ID/Search timestamp as the lookup key (i.e., hash key).

Note that, in this description, 512 partitions are used for explanatory purposes. However, the embodiment is not so limited. The number of partitions can be any number that is feasible and desirable. Likewise, a BDB is used in this description for explanatory purposes. However, the embodiment is not so limited. The system 100 may use any particular database that is feasible and desirable.

Accordingly, the backend system 110 uses the timestamp of the Search event (i.e., the SEARCH_TIMESTAMP field) to narrow down the Search space. The Search events and the Click events both contain the timestamp of the Search event. The backend system 110 uses the SEARCH_TIMESTAMP in the Click event to determine which commodity database to query. For every Click event, the backend system 110 only needs to open one commodity database because the backend system 110 has the partition number from the first optimization and because the backend system 110 already has the appropriate timestamp to query. The system 100 thereby provides a way to collect all of this useful Click information without embedding the Click information in the actual URL of the ad.

A second optimization is for the backend system 110 to map multiple Click events to the same Search event file while the Search event file is open. In order to reduce the number of input/output (I/O) operations, the backend system 110 sorts each Click event file in memory and partitions events based on the corresponding Search event file. After such a process, the backend system 110 may determine that multiple Click events all map to the same Search event file. For example, 5 Click event files match to Search event file number 201. In that case, the backend system 110 has to open the Search event file only once. The backend system 110 can perform the multiple matches between the Click events and the open Search event. Continuing with the example, the backend system 110 opens Search event file number 201 and performs 5 matches to the 5 corresponding Click events and then closes Search event file number 201. Thus, the backend system 110 is saving on the number of I/O operations that must be performed.

The backend system 110 partitions both the Search data and Click data on the same lookup key (i.e., hash key). Accordingly, a Click event and the matching Search event will appear in the same partition. In other words, if a Click event is present in partition X, then the corresponding Search event will also be present in partition X. The corresponding Search event cannot be in any of the other partitions. In other words, if a Click event is present in partition X, then the corresponding Search event cannot be in partition Y. By partitioning the data by the same hash key, the system 110 has narrowed down the search space by a factor of 512.

Each Click partition will contain a number of Click events. For each Click event, the backend system 110 finds the corresponding Search event in one of the commodity databases. When the backend system 110 finds the corresponding Search event, it is desirable for the backend system 110 to annotate the Click event with useful information from the Search event.

The backend system 110 chooses the Click partition size so that the backend system 110 can fit each partition into memory. The backend system 110 then sorts the Click events within a partition and searches the corresponding commodity databases one at a time rather than doing random access. For example, if the backend system 110 has 10 Click events that have corresponding Search events in the same commodity database, then the back end system 110 has to open the commodity database only once, rather than 10 times.

A third optimization is for the backend system 110 to carry out each Click partition lookup in parallel to reduce overall processing time. The backend system 110 can perform the matches (i.e., joins) in parallel. The parallel processing is possible because there is no overlap between the partitions. For example, a Click events in partition X matches to a Search event in partition X and no other partition. Accordingly, there will be no filing locking; there will not be any overlapping processing involving reading or writing to the same file. For example, partition number 1 through partition number 512 can all be run at the same time. This parallel processing reduces the overall latency of the complex processing.

Parallel processing can run even faster if the backend system increases the number of partitions (i.e., buckets). For example, if the number of partitions increases from 512 to 2000 buckets, then there will be more parallel processing and the overall processing will therefore be faster. In another example, if the number of partitions increases from 1 bucket to 2 buckets, then there will be twice as much processing being performed at once and the overall processing will therefore be about twice as fast. On the other hand, parallel processing will run slower if the backend system decreases the number of buckets. Thus, the speed of processing is proportional to the number of partitions.

A fourth optimization is for the backend system 110 to use statistical analysis to figure out an appropriate retention period of the Search commodity databases. For example, the backend system 110 may find that 99% of Click events are performed within 24 hours of a Search event. In this case, the backend system 110 may decide that this is sufficient accuracy and decide to delete Search events that are older than 24 hours in order to free up disk space for newer data files.

Note that a time period of 24 hours is used in this description for explanatory purposes. However, the embodiment is not so limited. The time period may be any length of time that is feasible and desirable.

A fifth optimization is for the backend system 110 to utilize cache memory for lookups (i.e., matching). The backend system 110 uses statistical analysis to determine the time period in which most of the Click events occur. For example, the backend system 110 may find that 80% of Click events occur within 1 hour of the Search event. In this scenario, the backend system 110 may build an in-memory cache of the latest 1 hour of Search events that the backend system 110 can use for even faster Search lookups; the Search events happening after that first hour will be built into disk memory. Accordingly, the backend system 110 first goes to the cache because 80% of the lookup will be in the cache; if a hit (i.e., match) is found, the backend system 110 returns the hit immediately; otherwise, the backend system 110 goes into disk memory to search for a hit. This a priori knowledge of the distribution of the data will allow the backend system 110 to find matches faster because cache memory is faster than disk memory.

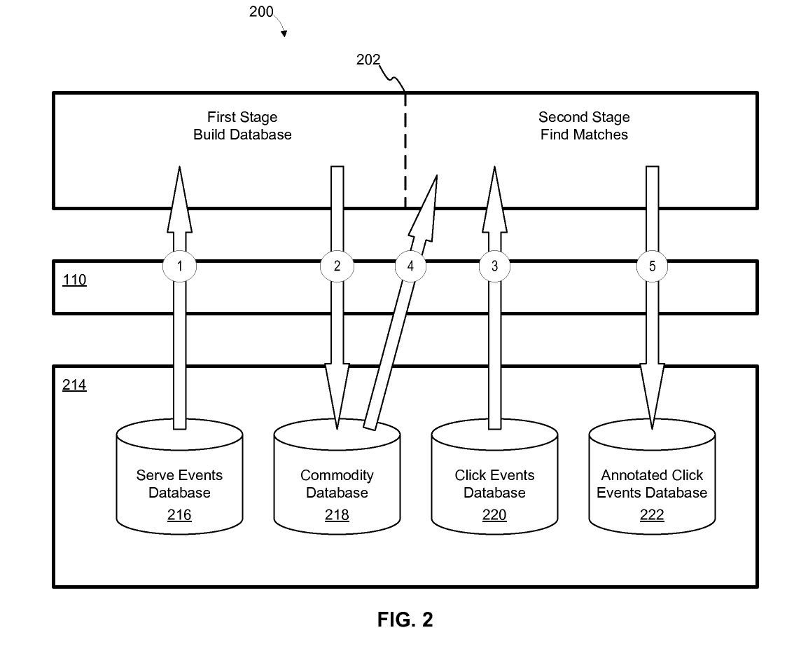

FIG. 2 is a block diagram of data flow 200 through commodity databases, in accordance with an embodiment of the present invention. The data flow 200 includes a two-stage process 202, including a first stage of building a commodity database and a second stage of finding matches. Data flows through the backend system 110, to and from various databases 210. The system manipulates the data in some manner during the two-stage process 202. Flow 1 involves the backend system 110 reading search events from a web server coupled to a database storing Search events. Flow 2 involves the backend system 110 building commodity databases from the search events. Flow 3 involves the backend system 110 reading Click events from a web server coupled to a database storing Click events. Flow 4 involves the backend system 110 searching a number of commodity databases for data collected a given period. For example, the backend system 110 may collect up to 288 commodity databases for Click event matches obtained over a 24 hour period. There are 288 five-minute intervals in 24 hours. Flow 5 involves the backend system 110 writing matched and unmatched clicks to a web server coupled to a database for storing the annotated Click events.

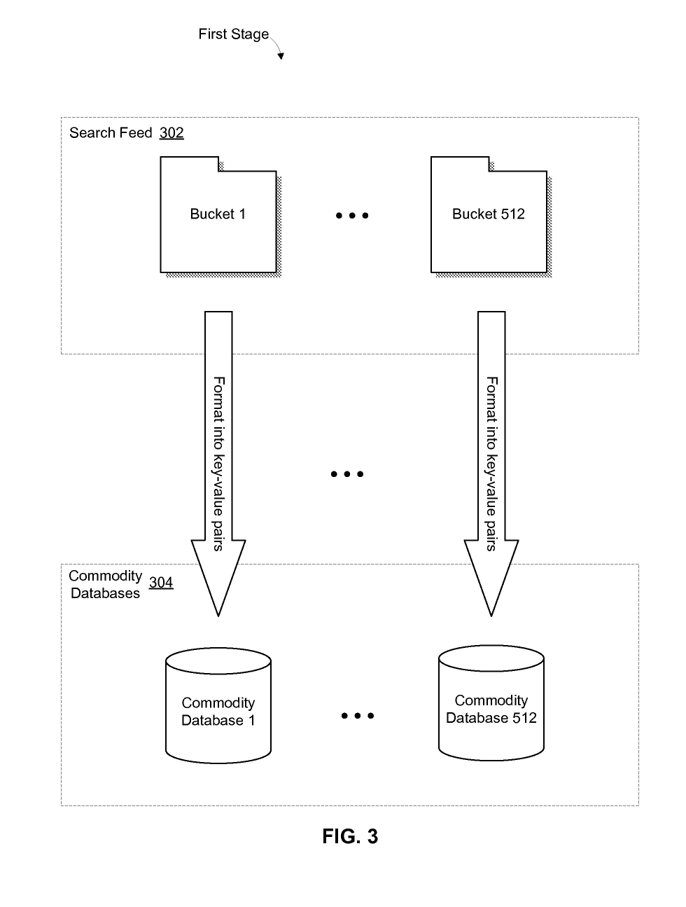

FIG. 3 is a more detailed block diagram of the first stage of FIG. 2, in accordance with an embodiment of the present invention. This first stage involves the system building commodity databases. The backend system reads from, for example, 512 bucket files in the search feed 302. The backend system partitions the search data by Search ID and Search Timestamp. The backend system parses events from each input file and writes the parsed the events as key-value pairs to a commodity database. Each Key is a Search ID and a Search Timestamp. Each Value is the rest of the event data. The backend system generates 512 commodity databases 304 for each 5-minute interval.

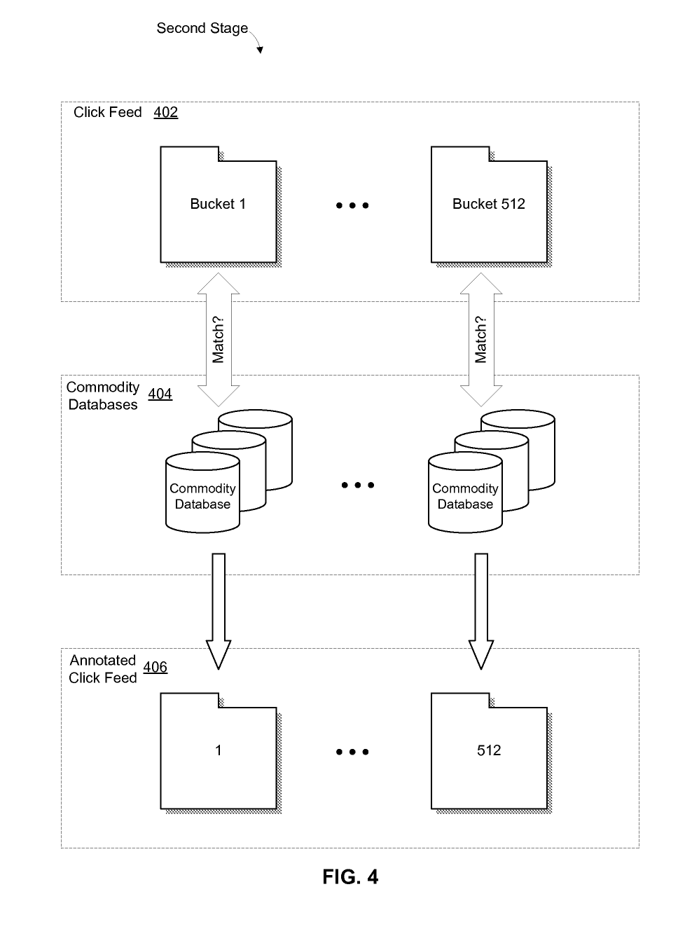

FIG. 4 is a more detailed block diagram of the second stage of FIG. 2, in accordance with an embodiment of the present invention. This second stage involves building commodity databases. The backend system reads click events from, for example, 512 bucket files in the click feed 402. The backend system compares Click events in each with a certain time period of Search events contained in a number of commodity databases 404. For example, the backend system compares Click events in each file with 24 hours of Search events contained in 288 commodity databases 404. The backend system has to read only one commodity database for each Click event because the backend system has done data partitioning and timestamping to narrow down the search. If the backend system finds a match, the backend system extracts metadata from the commodity database, adds the metadata to the Click event and writes the metadata to the annotated click feed 406. The backend system writes unmatched click events to feed without any additional metadata.

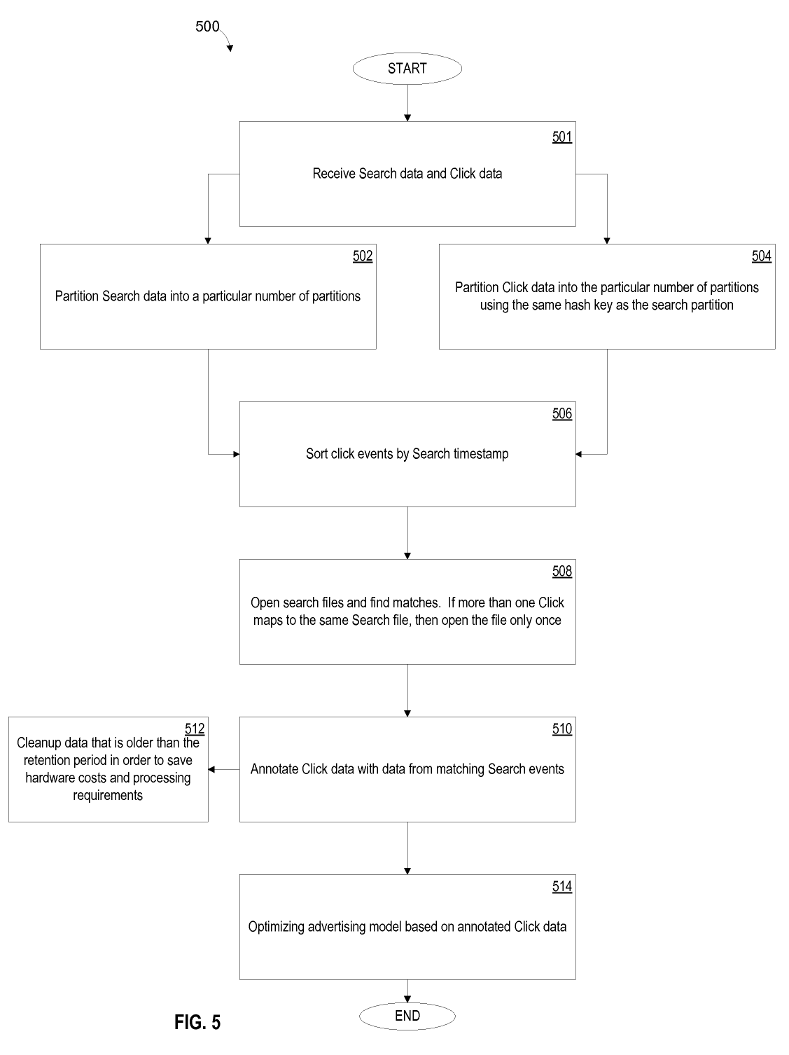

FIG. 5 is a flowchart of a method 500 for building components needed to match Click events with Search events in a fast and scalable manner, in accordance with an embodiment of the present invention. The method starts in step 501 where the system receives Search data and Click data from the front-end system. The backend system 110 of FIG. 1 may be configured to carry out step 501. Next, the method 500 moves to steps 502 and 504, which the system may perform at substantially the same time or in sequence. In step 502, the system partitions data search data received from one or more web servers into a particular number of partitions (e.g., 512 data buckets). The searches partition device 112 of FIG. 1 may be configured to carry out step 502. In step 504, the system partitions Click data received from one or more web servers into the particular number of partitions (e.g., 512 data buckets) using the same hash key as the search partition. The Clicks partition device 114 of FIG. 1 may be configured to carry out step 504.

Next, in step 506, the system sorts Click events by search timestamps. Then, in step 508, the system opens search files and finds matches. If more than one Click event maps to the same search file, then the system opens the file only once. The iterate device 116 may be configured to carry out steps 506 and 508. The method 500 then moves to step 510 where the system annotates click data based on the system matching of Search events. The annotate device 118 of FIG. 1 may be configured to carry out step 510. Next, in step 512, the system cleans up data that is older than the retention period (e.g., 24 hours) in order to save on hardware costs and processing requirements. The cleanup device 120 of FIG. 1 may be configured to carry out step 512. The method 500 then proceeds to step 514 where the system optimizes an advertising model based on annotated Click data. The optimization device 122 of FIG. 1 may be configured to carry out step 514. The method 500 is then at an end. The method 500 is an iterative process and may repeat as desired.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving first-type data and second-type data from one or more web servers, partitioning the first-type data into a particular number of first-type partitions, partitioning the second-type data into second-type partitions, wherein there are a same number of second-type partitions as the particular number of first-type partitions, sorting each first-type event by a second-type timestamp, opening second-type event files and finding first-type event matches, generating annotated second-type data by annotating each second-type event file with data from matching first-type events, and optimizing an advertising model based on the annotated second-type data, according to processes of the present invention.

### Advantages

The system of the present invention provides a way to perform fast Search event lookups (persistent hash-based joins). The system may use a generic algorithm for performing data lookups on numerous different types of data sets; in other words, the data sets do not have to be Clicks and Searches; the data sets can be any data that the backend system may want to join/correlate. The system may utilize commodity database software (e.g., Berkeley DB) to make data lookups faster. The system may carry out parallel processing to reduce overall processing time; for example, the system may build Berkeley databases in parallel; likewise, databases queries may happen in parallel. The system can partition data to reduce the space required for searching; the system needs to query only one (1) database file for each input Click event. URLs in search result pages will be smaller, making the load time of the webpage substantially faster. The information in the Click event is not limited by the standard 1024 character limit on URL lengths. Thus, over time, the backend system builds a better advertising model by being able to hone in more precisely on how ads perform in relation to particular searches (or in relation to some other user activity).

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of using commodity databases for parallelized and scalable solutions in Internet advertising, the method comprising:
receiving first-type data and second-type data from one or more web servers;
partitioning the first-type data into a particular number of first-type partitions;
partitioning the second-type data into second-type partitions, wherein there are a same number of second-type partitions as the particular number of first-type partitions;
sorting each first-type event by a second-type timestamp; and
opening second-type event files and finding first-type event matches.

2. The method of claim 1, wherein the first-type data is Search data, and wherein the second-type data is Click data.

3. The method of claim 1, further comprising generating annotated second-type data by annotating each second-type event file with data from matching first-type events.

4. The method of claim 1, further comprising cleaning up data that is older than a retention period.

5. The method of claim 3, further comprising optimizing an advertising model based on the annotated second-type data.

6. The method of claim 1, wherein the partitioning the first-type data and the partitioning the second-type data reduces a scope of the first-type space, wherein the partitioning the first-type data comprises splitting the first-type data into a first-type identification and a first-type timestamp, and wherein the partitioning the second-type data comprises splitting the second-type data into the first-type identification and the first-type timestamp.

7. The method of claim 1, wherein the opening second-type event files and finding first-type event matches comprises mapping multiple second-type events to an opened first-type file.

8. The method of claim 1, wherein the opening second-type event files and finding first-type event matches comprises performing opening and matching operations in parallel amongst all partitions.

9. The method of claim 1, further performing statistical analysis on the first-type data and on the second-type data in order to determine an appropriate retention period for data received.

10. The method of claim 1, wherein the opening second-type event files and finding first-type event matches comprises utilizing cache memory for at least a portion of the opening and matching.

11. An apparatus for using commodity databases for parallelized and scalable solutions in Internet advertising, the apparatus being configured to receive first-type data and second-type data from one or more web servers, the apparatus comprising:
a first-type partitions device configured to partition the first-type data into a particular number of first-type partitions;
a second-type partitions device configured to partition the second-type data into second-type partitions, wherein there are a same number of second-type partitions as the particular number of first-type partitions;
an iterate device configured to sort each first-type event by a second-type timestamp, to open second-type event files, and to find first-type event matches.

12. The apparatus of claim 11, wherein the first-type data is Search data, and wherein the second-type data is Click data.

13. The apparatus of claim 11, further comprising an annotate device configured to generate annotated second-type data by annotating each second-type event file with data from matching first-type events.

14. The apparatus of claim 11, wherein the first-type partition device and the second-type partition device are configured to reduce a scope of the first-type space, wherein the first-type partition device is configured to split the first-type data into a first-type identification and a first-type timestamp, and wherein the second-type partition device is configured to split the second-type data into the first-type identification and the first-type timestamp.

15. The apparatus of claim 11, wherein the iterate device is further configured to map multiple second-type events to an opened first-type file.

16. The apparatus of claim 11, wherein the iterate device is further configured to perform opening and matching operations in parallel amongst all partitions.

17. The apparatus of claim 11, wherein the iterate device is further configured to utilize cache memory for at least a portion of the opening and matching.

18. A system for using commodity databases for parallelized and scalable solutions in Internet advertising, the system including a conglomeration of apparatuses, each apparatus comprising at least one of:
a first-type partitions device configured to partition the first-type data into a particular number of first-type partitions;
a second-type partitions device configured to partition the second-type data into second-type partitions, wherein there are a same number of second-type partitions as the particular number of first-type partitions;
an iterate device configured to sort each first-type event by a second-type timestamp, to open second-type event files, and to find first-type event matches.

19. The system of claim 18, wherein the first-type data is Search data, and wherein the second-type data is Click data.

20. The system of claim 18, further comprising an annotate device configured to generate annotated second-type data by annotating each second-type event file with data from matching first-type events.

21. The system of claim 18, wherein the first-type partition device and the second-type partition device are configured to reduce a scope of the first-type space, wherein the first-type partition device is configured to split the first-type data into a first-type identification and a first-type timestamp, and wherein the second-type partition device is configured to split the second-type data into the first-type identification and the first-type timestamp.

22. The system of claim 18, wherein the iterate device is further configured to map multiple second-type events to an opened first-type file.

23. The system of claim 18, wherein the iterate device is further configured to perform opening and matching operations in parallel amongst all partitions.

24. The system of claim 18, wherein the iterate device is further configured to utilize cache memory for at least a portion of the opening and matching.

25. A computer readable medium carrying one or more instructions for using commodity databases for parallelized and scalable solutions in Internet advertising, wherein the one or more instructions, when executed by one or more processors, cause the one or more processors to perform the steps of:
receiving first-type data and second-type data from one or more web servers;
partitioning the first-type data into a particular number of first-type partitions;
partitioning the second-type data into second-type partitions, wherein there are a same number of second-type partitions as the particular number of first-type partitions;
sorting each first-type event by a second-type timestamp; and
opening second-type event files and finding first-type event matches.
